(19) United States
(12) Patent Application Publication
(10) Pub. No.: US 2002/0068542 A1
(43) Pub. Date: Jun. 6, 2002

(54) Hands free mobile phone system

(76) Inventor: Kevin C. Copley, Bexelyheath (GB)

Correspondence Address: Kaardal & Associates, PC, Att: Ivar M. Kaardal, Suite 250, 3500 South First Ave. Circle, Sioux Falls, SD, 57105-5802, US

(21) Appl. No.: 09/728,870

(22) Filed: Dec. 1, 2000

(51) Int. Cl. H04B 1/38

(52) U.S. Cl. 455/345; 455/569; 455/568

(57) ABSTRACT

A hands free mobile phone system for allowing a user of a cellular phone to hear a person on the radio system of a vehicle. The hands free mobile phone system includes a microprocessor that selectively breaks an electrical connection between the radio and the speakers and sends an audio signal to the speakers received from the cellular phone. The radio is electrically coupled to the microprocessor, and the microprocessor is electrically coupled to the speakers. An actuator for selectively actuating the microprocessor is operationally coupled to the microprocessor. A cord electrically couples the cellular phone to the microprocessor.

### BACKGROUND OF THE INVENTION

1. Field of the Invention

The present invention relates to devices for integrating a cellular phone with a vehicular radio system and more particularly pertains to a new hands free mobile phone system for allowing a user of a cellular phone to hear a person on the radio system of a vehicle.

2. Description of the Prior Art

The use of devices for integrating a cellular phone with a vehicular radio system is known in the prior art. More specifically, devices for integrating a cellular phone with a vehicular radio system heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U.S. Pat. No. 5,404,391; U.S. Pat. No. 5,243,640; U.S. Pat. No. 5,867,794; U.S. Pat. No. 4,905,270; U.S. Des. Pat. No. 308,058; and U.S. Pat. No. 5,627,876.

While these devices fulfill their respective, particular objectives and requirements, the aforementioned patents do not disclose a new hands free mobile phone system. The inventive device includes a microprocessor that selectively breaks an electrical connection between the radio and the speakers and sends an audio signal to the speakers received from the cellular phone. The radio is electrically coupled to the microprocessor, and the microprocessor is electrically coupled to the speakers. An actuator for selectively actuating the microprocessor is operationally coupled to the microprocessor. A cord electrically couples the cellular phone to the microprocessor.

In these respects, the hands free mobile phone system according to the present invention substantially departs from the conventional concepts and designs of the prior art, and in so doing provides an apparatus primarily developed for the purpose of allowing a user of a cellular phone to hear a person on the radio system of a vehicle.

### SUMMARY OF THE INVENTION

In view of the foregoing disadvantages inherent in the known types of devices for integrating a cellular phone with a vehicular radio system now present in the prior art, the present invention provides a new hands free mobile phone system construction wherein the same can be utilized for allowing a user of a cellular phone to hear a person on the radio system of a vehicle.

The general purpose of the present invention, which will be described subsequently in greater detail, is to provide a new hands free mobile phone system apparatus and method which has many of the advantages of the devices for integrating a cellular phone with a vehicular radio system mentioned heretofore and many novel features that result in a new hands free mobile phone system which is not anticipated, rendered obvious, suggested, or even implied by any of the prior art devices for integrating a cellular phone with a vehicular radio system, either alone or in any combination thereof.

To attain this, the present invention generally comprises a microprocessor that selectively breaks an electrical connection between the radio and the speakers and sends an audio signal to the speakers received from the cellular phone. The radio is electrically coupled to the microprocessor, and the microprocessor is electrically coupled to the speakers. An actuator for selectively actuating the microprocessor is operationally coupled to the microprocessor. A cord electrically couples the cellular phone to the microprocessor.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new hands free mobile phone system apparatus and method which has many of the advantages of the devices for integrating a cellular phone with a vehicular radio system mentioned heretofore and many novel features that result in a new hands free mobile phone system which is not anticipated, rendered obvious, suggested, or even implied by any of the prior art devices for integrating a cellular phone with a vehicular radio system, either alone or in any combination thereof.

It is another object of the present invention to provide a new hands free mobile phone system which may be easily and efficiently manufactured and marketed.

It is a further object of the present invention to provide a new hands free mobile phone system which is of a durable and reliable construction.

An even further object of the present invention is to provide a new hands free mobile phone system which is susceptible of a low cost of manufacture with regard to both materials and labor, and which accordingly is then susceptible of low prices of sale to the consuming public, thereby making such hands free mobile phone system economically available to the buying public.

Still yet another object of the present invention is to provide a new hands free mobile phone system which provides in the apparatuses and methods of the prior art some of the advantages thereof, while simultaneously overcoming some of the disadvantages normally associated therewith.

Still another object of the present invention is to provide a new hands free mobile phone system for allowing a user of a cellular phone to hear a person on the radio system of a vehicle.

Yet another object of the present invention is to provide a new hands free mobile phone system which includes a microprocessor that selectively breaks an electrical connection between the radio and the speakers and sends an audio signal to the speakers received from the cellular phone. The radio is electrically coupled to the microprocessor, and the microprocessor is electrically coupled to the speakers. An actuator for selectively actuating the microprocessor is operationally coupled to the microprocessor. A cord electrically couples the cellular phone to the microprocessor.

Still yet another object of the present invention is to provide a new hands free mobile phone system that is retrofittable to existing vehicle radio systems.

Even still another object of the present invention is to provide a new hands free mobile phone system that allows a user to have a cellular phone conversation without having to hold the cellular phone or wear a head set in order to hear the cellular phone.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic in use view of a new hands free mobile phone system according to the present invention.

FIG. 2 is a schematic plan view of the present invention.

FIG. 3 is an electronic schematic view of the present invention.

### DESCRIPTION OF THE PREFERRED EMBODIMENT

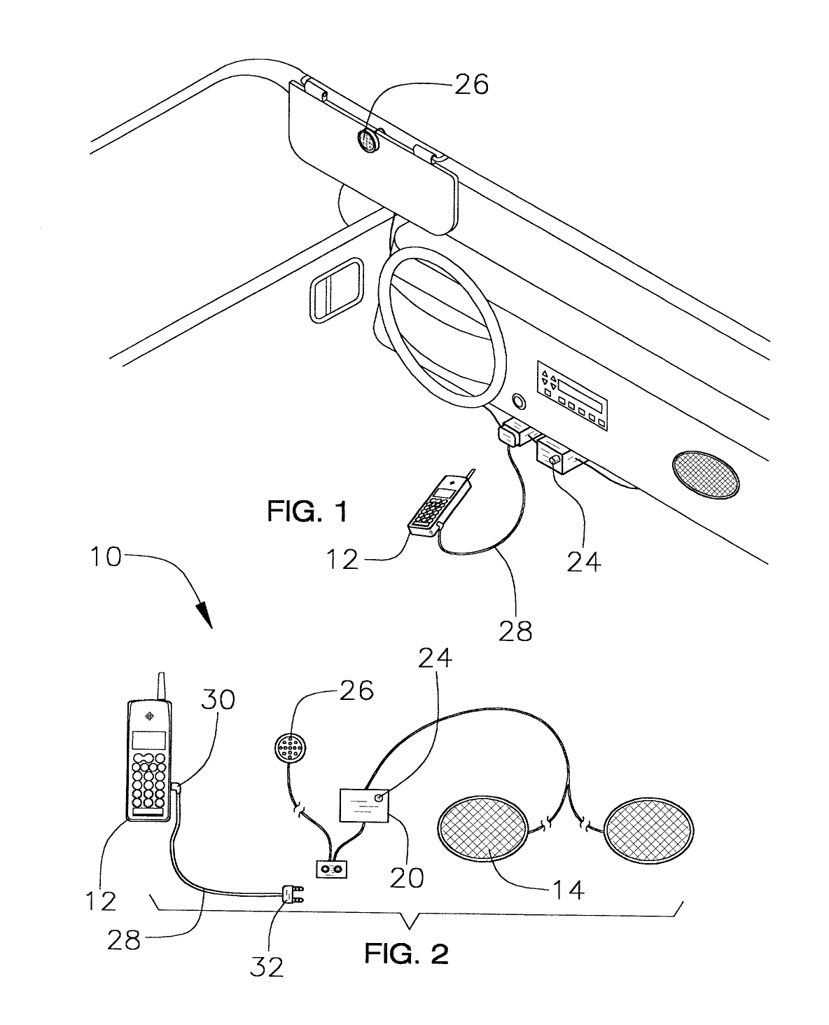

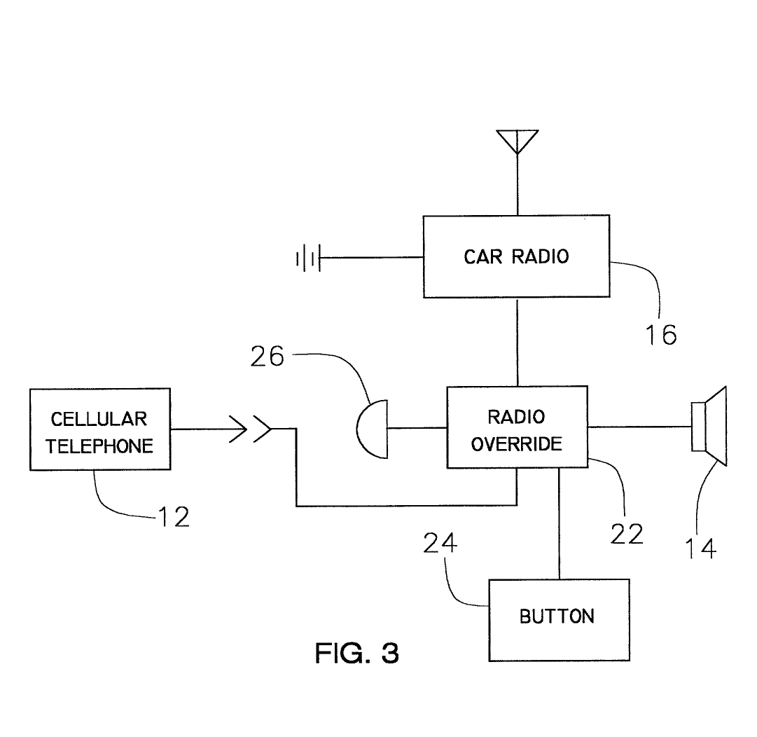

With reference now to the drawings, and in particular to FIGS. 1 through 3 thereof, a new hands free mobile phone system embodying the principles and concepts of the present invention and generally designated by the reference numeral 10 will be described.

As best illustrated in FIGS. 1 through 3, the hands free mobile phone system 10 generally is a device for integrating a cellular/mobile telephone 12 with speakers 14 of a vehicle's audio system. The vehicle's audio system being a conventional and including a radio 16. The device 10 includes a housing 20, which is mounted in the vehicle, preferably on the front dashboard portion of the vehicle.

A microprocessor 22 selectively breaks an electrical connection between the radio 16 and the speakers 14 and sends an audio signal received from the cellular phone 12 to the speakers 14. The radio 16 is electrically coupled to the microprocessor 22. The microprocessor 22 is electrically coupled to the speakers 14. The microprocessor 22 is positioned in the housing 20.

An actuator 24 for selectively turning the microprocessor on and off is operationally coupled to the microprocessor 22 and ideally comprises a button positioned on the housing.

A microphone 26 for capturing audible sounds and electrically transferring the audible sounds to the cellular phone 12 is electrically coupled to the microprocessor 22. The microphone 26 is mounted in the vehicle.

A cord 28 electrically couples the cellular phone 12 to the microprocessor 22. The cord 28 has a first end and second end each having a male plug electrically coupled thereto. A first 30 of the male plugs is removably couplable to the cellular phone 12, and a second 32 of the male plugs is removably couplable to the microprocessor 22.

In use, the cellular phone 12 is electrically coupled to the microprocessor 22 by the cord 28. When a phone call is received or begun, the actuator turns 24 on the microprocessor 22 so that the incoming sounds from the cellular phone 12 are transferred to the speakers 14 of the vehicle. The user may use the microphone built into the cellular phone 12 or they may use a separate microphone 26 coupled to the microprocessor 22. The audible sounds captured by the microphone 22 are transferred to the cellular phone 12. In this manner, a user of the cellular phone 12 need not have any contact with the cellular phone 12, nor wear a headset in order to hear the incoming call.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An audio integrating device for integrating a cellular telephone with speakers of a vehicle's audio system, the vehicle's audio system including a radio, said device comprising:
a microprocessor for selectively breaking an electrical connection between said radio and said speakers and for sending an audio signal to said speakers received from said cellular phone, said radio being electrically coupled to said microprocessor, said microprocessor being electrically coupled to said speakers;
an actuator for selectively actuating said microprocessor, said actuator being operationally coupled to said microprocessor; and
a cord for electrically coupling said cellular phone to said microprocessor.

2. The audio integrating device as in claim 1, further comprising:
an actuator for selectively actuating said microprocessor, said actuator being operationally coupled to said microprocessor, said actuator comprising a button positioned on said housing.

3. The audio integrating device as in claim 1, further comprising:
a microphone for capturing audible sounds and electrically transferring said audible sounds to said cellular phone, said microphone being electrically coupled to said microprocessor.

4. The audio integrating device as in claim 1, wherein said cord has a first end and second end each having a male plug electrically coupled thereto, a first of said male plugs being removably couplable to said cellular phone, a second of said male plugs being removably couplable to said microprocessor.

5. An audio integrating device for integrating a cellular telephone with speakers of a vehicle's audio system, the vehicle's audio system including a radio, said device comprising:
a housing, said housing being mounted in said vehicle;
a microprocessor for selectively breaking an electrical connection between said radio and said speakers and for sending an audio signal to said speakers received from said cellular phone, said radio being electrically coupled to said microprocessor, said microprocessor being electrically coupled to said speakers, said microprocessor being positioned in said housing;
an actuator for selectively actuating said microprocessor, said actuator being operationally coupled to said microprocessor, said actuator comprising a button positioned on said housing;
a microphone for capturing audible sounds and electrically transferring said audible sounds to said cellular phone, said microphone being electrically coupled to said microprocessor, said microphone being mounted in said vehicle;
a cord for electrically coupling said cellular phone to said microprocessor, said cord having a first end and second end each having a male plug electrically coupled thereto, a first of said male plugs being removably couplable to said cellular phone, a second of said male plugs being removably couplable to said microprocessor; and
wherein said audible sounds captured by said microphone are transferred to said cellular phone.
